(19) United States
(12) Patent Application Publication
(10) Pub. No.: US 2012/0055866 A1
(43) Pub. Date: Mar. 8, 2012

(54) UNIVERSAL CARTRIDGE FILTER HOUSING

(76) Inventor: Ying-Chen LIN, Hsinchu (TW)

(21) Appl. No.: 13/221,150

(22) Filed: Aug. 30, 2011

(30) Foreign Application Priority Data
Sep. 2, 2010 (CN) 201020515329.9

(51) Int. Cl. B01D 35/30

(52) U.S. Cl. 210/444

(57) ABSTRACT

A universal cartridge filter housing has an upper cap and a lower housing. An inlet and a first outlet are formed through the upper cap, and an inlet mouth and an first outlet mouth are respectively formed around and upwardly protrude from top openings of the inlet and the first outlet so that the universal cartridge filter housing is universally applicable to all sorts of filter cores and serves as a standard part to significantly reduce the production cost and users' expense and facilitate extensive promotion and usage. As the inlet mouth and the first outlet mouth are concentrated on a top of the upper cap, multiple universal cartridge filter housings can be gathered together for operation, flexible tubes connected to the inlet mouth and the first outlet mouth and the second outlet mouth can be also centralized, thereby facilitating replacement of each filter core and enhancing the work efficiency at maintenance.

### BACKGROUND OF THE INVENTION

1. Field of the Invention

The present invention relates to a cartridge filter housing for a water filter, and more particularly to a universal cartridge filter housing satisfying accommodation of all sorts of filter cores.

2. Description of the Related Art

Many types of filter cores, such as polypropylene filter cores, activated carbon filter cores, reverse osmosis (RO) filter cores, resin filter cores and the like, are available to conventional water filters in the market. To thoroughly purify water, a water filter is usually equipped with various filter cartridges therein at the same time.

When a filter core is mounted in a water filter, the filter core is first mounted in a filter cartridge. The filter cartridge is then fixed in the water filter, and ducts are respectively connected with the inlets and outlets of all the filter cartridges in the water filter. However, each filter core has its specific filter cartridges, and the inlets and outlets of different filter cartridges differ in location and number. Besides, different filter cartridges oftentimes differ in size. As a result, different filter cartridges are less likely to be interchanged. Accordingly, the low interchangeability inevitably increases the manufacturing costs of water filters and the final costs to customers.

### SUMMARY OF THE INVENTION

An objective of the present invention is to provide a universal cartridge filter housing satisfying accommodation of all sorts of filter cores.

To achieve the foregoing objective, the universal cartridge filter housing has a lower housing and an upper cap.

The lower housing has an open top end and a closed end.

The upper cap is hermetically connected to the lower housing to define a sealed chamber adapted for mounting a filter cartridge and has an inlet, a first outlet, an inlet mouth and a first outlet mouth. The inlet and the first outlet are vertically formed through the upper cap. The inlet mouth and the first outlet mouth are respectively formed around and upwardly protrude from top openings of the inlet and the first outlet.

Preferably, the upper cap further has a second outlet vertically formed through the upper cap and a second outlet mouth formed around and upwardly protruding from a top opening of the second outlet.

Preferably, the inlet mouth, the first outlet mouth and the second outlet mouth are straight.

Preferably, the inlet mouth, the first outlet mouth and the second outlet mouth are curved.

Preferably, the inlet mouth and the first outlet mouth are integrally formed on the upper cap.

Preferably, the lower housing has an annular rib integrally formed on and protruding upwardly from a bottom thereof.

The present invention is advantageous in having an inlet and a first outlet formed through the upper cap, and an inlet mouth and a first outlet mouth respectively formed around and upwardly protruding from top openings of the inlet and the first outlet so that polypropylene filter cores, activated carbon filter cores, RO filter cores, resin filter cores and the like can be accommodated in the universal cartridge filter housing for operation. Hence, the universal cartridge filter housing is universally applicable to all sorts of filter cores and serves as a standard part to significantly reduce the production cost and users' expense and facilitate extensive promotion and usage. Unlike the scattering inlet mouths, first outlet mouths and second outlet mouths of conventional cartridge filter housings, the inlet mouth, the first outlet mouth and the second outlet mouth of the present invention are concentrated on a top of the upper cap, and thus, multiple universal cartridge filter housings can be gathered together for operation and flexible tubes connected to the inlet mouth, the first outlet mouth and the second outlet mouth can be also centralized, thereby facilitating easy replacement of each filter core and enhancing the work efficiency at maintenance. Accordingly, the present invention achieves to be simple in structure, convenient in production and universally applicable in housing all sorts of filter cartridges.

Additionally, the present invention is advantageous in having the second outlet for an RO filter core to be mounted inside the universal cartridge filter housing for operation. If not required for operation, the second outlet can be blocked.

Other objectives, advantages and novel features of the invention will become more apparent from the following detailed description when taken in conjunction with the accompanying drawings.

### BRIEF DESCRIPTION OF THE DRAWINGS

FIG. 1 is a cross-sectional side view of a first embodiment of a universal cartridge filter housing in accordance with the present invention;

FIG. 2 is a cross-sectional side view of a second embodiment of a universal cartridge filter housing in accordance with the present invention; and

FIG. 3 is a side view of the universal cartridge filter housing in FIG. 2.

### DETAILED DESCRIPTION OF THE INVENTION

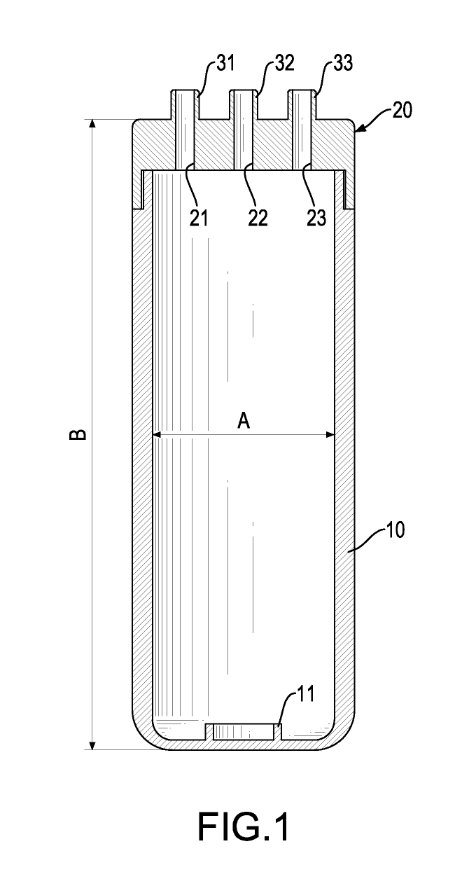

With reference to FIG. 1, a first embodiment of a universal cartridge filter housing in accordance with the present invention has a lower housing 10 and an upper cap 20.

The lower housing 10 has an open top end, a closed end and an annular rib 11. The annular rib 11 is integrally formed on and protruding upwardly from an inner bottom of the lower housing.

The upper cap 20 is hermetically connected to the lower housing 10 to define a sealed chamber for mounting a filter cartridge, and has an inlet 21, a first outlet 22, a second outlet 23, an inlet mouth 31, a first outlet mouth 32 and a second outlet mouth 33. The inlet 21, the first outlet 22 and the second outlet 23 are perpendicularly formed through the upper cap 20. The inlet mouth 31, the first outlet mouth 32 and the second outlet mouth 33 are respectively formed around and upwardly protrude from top openings of the inlet 21, the first outlet 22 and the second outlet 23. The inlet mouth 31, the first outlet mouth 32 and the second outlet mouth 33 are straight and are integrally formed on the upper cap 20.

The advantages of the present invention lie in that the inlet 21, the first outlet 22 and the second outlet 23 are perpendicularly formed through the upper cap 20, and the inlet mouth 31, the first outlet mouth 32 and the second outlet mouth 33 are respectively formed around and upwardly protrude from the top openings of the inlet 21, the first outlet 22 and the second outlet 23 so that a polypropylene filter core, an activated carbon filter core, an RO filter core, a resin filter core or the like can be mounted on the annular rib 11 and inside the chamber of the universal cartridge filter housing to make the universal cartridge filter housing a standard part to be assembled with all kinds of filter cartridges for operation. Accordingly, the manufacturing cost of the water filter and user cost can be significantly lowered, thereby facilitating extensive promotion and usage. Meanwhile, unlike the scattering inlet mouths, first outlet mouths and second outlet mouths of conventional cartridge filter housings, the inlet mouth 31, the first outlet mouth 32 and the second outlet mouth 33 of the present invention are concentrated on a top of the upper cap 20, and thus, multiple universal cartridge filter housings can be gathered together for operation and flexible tubes connected to the inlet mouth 31, the first outlet mouth 32 and the second outlet mouth 33 can be also centralized, thereby facilitating easy replacement of each filter core and enhancing the work efficiency at maintenance. Accordingly, the present invention achieves to be simple in structure, convenient in production and universally applicable in housing all sorts of filter cartridges.

Moreover, with the second outlet 23 formed through the upper cap 20, an RO filter core is feasible to be mounted inside the universal cartridge filter housing for operation. If not required for operation, the second outlet 23 can be blocked.

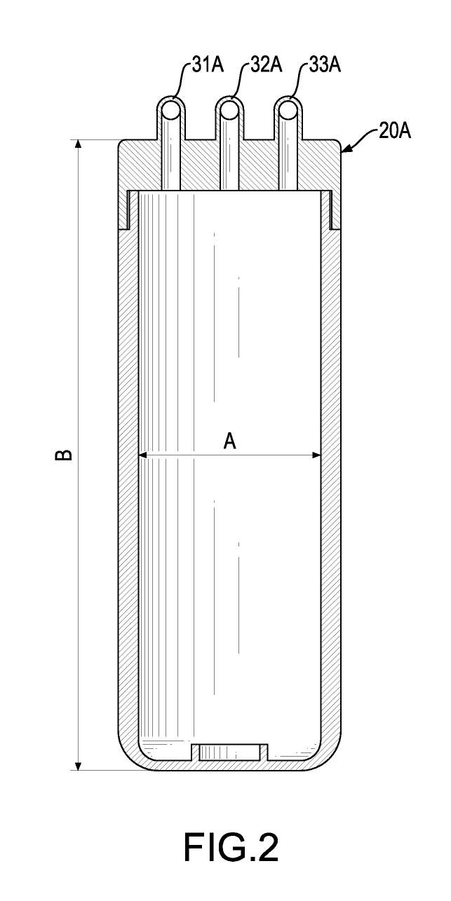

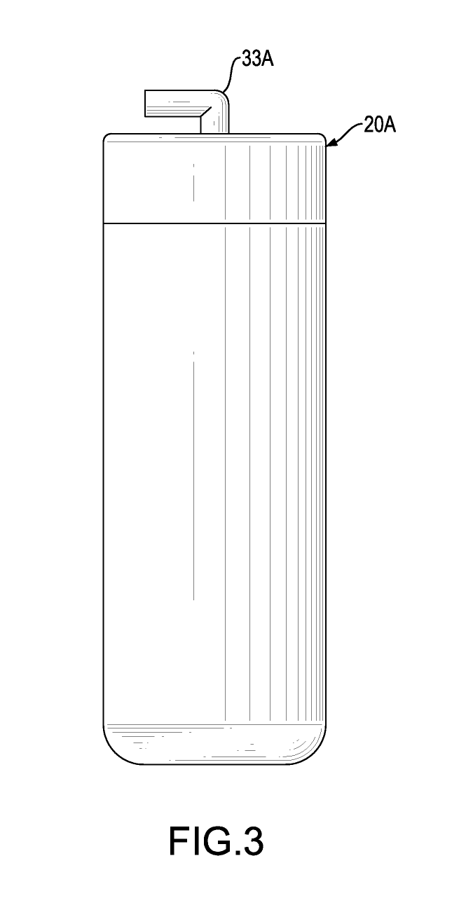

With reference to FIGS. 2 and 3, a second embodiment of a universal cartridge filter housing in accordance with the present invention is shown. The present embodiment differs from the foregoing embodiment in that the inlet mouth 31A, the first outlet mouth 32A and the second outlet mouth 33A of the upper cap 20A are curved.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A universal cartridge filter housing comprising:
a lower housing having an open top end and a closed end; and
an upper cap hermetically connected to the lower housing to define a sealed chamber adapted for mounting a filter cartridge, and having:
an inlet and a first outlet perpendicularly formed through the upper cap;
an inlet mouth and a first outlet mouth respectively formed around and upwardly protruding from top openings of the inlet and the first outlet.

2. The universal cartridge filter housing as claimed in claim 1, wherein the inlet mouth and the first outlet mouth are straight.

3. The universal cartridge filter housing as claimed in claim 1, wherein the inlet mouth and the first outlet mouth are curved.

4. The universal cartridge filter housing as claimed in claim 1, wherein the upper cap further has:
a second outlet perpendicularly formed through the upper cap; and
a second outlet mouth formed around and upwardly protruding from a top opening of the second outlet.

5. The universal cartridge filter housing as claimed in claim 4, wherein the inlet mouth, the first outlet mouth and the second outlet mouth are straight.

6. The universal cartridge filter housing as claimed in claim 4, wherein the inlet mouth, the first outlet mouth and the second outlet mouth are curved.

7. The universal cartridge filter housing as claimed in claim 1, wherein the inlet mouth and the first outlet mouth are integrally formed on the upper cap.

8. The universal cartridge filter housing as claimed in claim 2, wherein the inlet mouth and the first outlet mouth are integrally formed on the upper cap.

9. The universal cartridge filter housing as claimed in claim 3, wherein the inlet mouth and the first outlet mouth are integrally formed on the upper cap.

10. The universal cartridge filter housing as claimed in claim 4, wherein the inlet mouth, the first outlet mouth and the second outlet mouth are integrally formed on the upper cap.

11. The universal cartridge filter housing as claimed in claim 5, wherein the inlet mouth, the first outlet mouth and the second outlet mouth are integrally formed on the upper cap.

12. The universal cartridge filter housing as claimed in claim 6, wherein the inlet mouth, the first outlet mouth and the second outlet mouth are integrally formed on the upper cap.

13. The universal cartridge filter housing as claimed in claim 1, wherein the lower housing has an annular rib integrally formed on and protruding upwardly from an inner bottom of the lower housing.

14. The universal cartridge filter housing as claimed in claim 2, wherein the lower housing has an annular rib integrally formed on and protruding upwardly from an inner bottom of the lower housing.

15. The universal cartridge filter housing as claimed in claim 3, wherein the lower housing has an annular rib integrally formed on and protruding upwardly from an inner bottom of the lower housing.

16. The universal cartridge filter housing as claimed in claim 4, wherein the lower housing has an annular rib integrally formed on and protruding upwardly from an inner bottom of the lower housing.

17. The universal cartridge filter housing as claimed in claim 9, wherein the lower housing has an annular rib integrally formed on and protruding upwardly from an inner bottom of the lower housing.

18. The universal cartridge filter housing as claimed in claim 10, wherein the lower housing has an annular rib integrally formed on and protruding upwardly from an inner bottom of the lower housing.

19. The universal cartridge filter housing as claimed in claim 11, wherein the lower housing has an annular rib integrally formed on and protruding upwardly from an inner bottom of the lower housing.

20. The universal cartridge filter housing as claimed in claim 12, wherein the lower housing has an annular rib integrally formed on and protruding upwardly from an inner bottom of the lower housing.
